(19) United States
(12) Patent Application Publication
(10) Pub. No.: US 2004/0260603 A1
(43) Pub. Date: Dec. 23, 2004

(54) Electronic purchasing method

(75) Inventor: Gioacchino Marmotta, Bondi Junction (AU)

Correspondence Address: RYDER IP LAW, PC, DOUGLAS J. RYDER, 3669 CONCORD ROAD, DOYLESTOWN, PA, 18901, US

(73) Assignee: Marison Corporation Pty Ltd, Bondi Junction (AU)

(21) Appl. No.: 10/818,934

(22) Filed: Apr. 5, 2004

(30) Foreign Application Priority Data
Apr. 5, 2003 (AU) 2003 901 498
Oct. 29, 2003 (AU) 2003 259 582

(51) Int. Cl. G06F 17/60

(52) U.S. Cl. 705/13; 705/16

(57) ABSTRACT

An electronically facilitated, two phase, transaction system for the purchase and confirmation of a ticket in an event having a timetable of event times, comprising: —

means for purchasing an exercisable option right in the ticket through a first low or no cost, non-intermediary assisted channel, as hereinbefore defined, and

means for exercising the option right by confirming details for use of that ticket through a second low or no cost, non-intermediary assisted channel as hereinbefore defined.

### FIELD OF INVENTION

The present invention relates generally to the field of electronic commerce and, more particularly, to an electronically facilitated, two phase, transaction system for the purchase and confirmation of a ticket in an event having a timetable of event times in a non-intermediary assisted manner.

The invention has particular application to the purchase and confirmation of airline tickets through a non-intermediary assisted system, whereby, in a first phase or stage, a user purchases airline ticket option rights, and in a second phase or stage, the user, at a time of convenience, exercises the option rights by confirming airline travel arrangements, such as departure time and flight route.

For ease of understanding, the invention shall be described in relation to that application, although it is to be understood that the scope of the invention is not limited thereto, but may have other applications, such as in the purchase and confirmation of interstate train tickets, or in the purchase and confirmation of tickets in a sporting event having a schedule or timetable of event dates.

### BACKGROUND ART

Any discussion of the prior art throughout the specification should not be considered as an admission that such prior art is widely known or forms part of the common general knowledge in the field.

The majority of airline ticket reservations are currently processed through a distribution channel structure that involves several intermediary assisted channels. Such intermediaries or intermediary assisted channels are herein defined to include travel agents, internet travel booking sites, Global Distribution System (GDS) providers, and other fee or commission charging channels involved currently in the purchase and/or confirmation of the airline ticket or ticket that is relevant to the present invention. Hence, a non-intermediary assisted channel is herein defined as a channel not involved currently in the purchase and/or confirmation of the airline or other ticket.

Travel agents and airlines typically pay a fixed fee per air segment to a GDS provider for providing an electronic link to airline booking systems for confirming travel details. Airlines also compensate travel agents (including internet travel booking sites) with a percentage commission per air segment.

Drawbacks to the current distribution channel structure include: 1) fees and commissions can account for up to 20% of the cost of an airline ticket, 2) in a highly competitive airline industry with falling ticket prices, the GDS provider fee component becomes a significant cost, 3) GDS providers continue to increase fees that further reduces travel agent and airline revenue margins, 4) airlines are reducing travel agent commissions in order to minimise margin losses, 5) internet travel booking sites for airlines and travel agents only attract internet users that represent less than 50% of the population in most countries, and 6) many internet travel booking sites for airlines and travel agents still require payment of agent commissions and event GDS fees.

Although the internet has reduced the number of intermediary assisted channels to some degree, airlines are still bound to the current distribution channel structure to ensure a viable market size.

It is recognized by the present inventor that the intermediary costs associated with the current distribution channel structure can be eliminated or significantly reduced if airline tickets, and especially discounted domestic airline tickets, are offered for purchase as an exercisable option right through, say, a retail channel where other goods may be purchased, such as a supermarket, department store, or convenience store, or some other low or no cost, non-intermediary assisted channel, thus avoiding the payment of any fees or commissions to intermediaries involved currently in the purchase of the airline ticket. Once purchased, those option rights may be exercised by confirming airline travel details for that ticket through, say, a call centre or an electronic communication channel, such as an automatic teller machine (ATM), or other low or no cost, non-intermediary assisted channel, thus avoiding the payment of any fees or commissions to intermediaries involved currently in the confirmation of the airline ticket.

The electronically facilitated, two phase, transaction system described above is also recognised by the present inventor to offer a more convenient distribution channel structure to users than the current distribution channel structure because it is compatible with current shopping behaviour, where day to day purchases are made through retail channels, and where automatic teller machines and other electronic communication channels are commonly visited or made available to a shopper.

It is an object of the present invention to provide an electronically facilitated, two phase, transaction system for the purchase and confirmation of tickets in an event having a timetable of event times that overcomes, or at least substantially ameliorates, the drawbacks of the current distribution channel structure for airline ticket purchase and confirmation.

It is a preferred object of the present invention to provide an electronically facilitated, two phase, transaction system for the purchase and confirmation of airline tickets that avoids the payment of any fees or commissions to intermediaries involved currently in the purchase and/or confirmation of airline tickets, and that offers a more convenient distribution channel structure to users than the current distribution channel structure.

### SUMMARY OF THE INVENTION

According to the invention, there is provided an electronically facilitated, two phase, transaction system for the purchase and confirmation of a ticket in an event having a timetable of event times, comprising: —

means for purchasing an exercisable option right in the ticket through a first low or no cost, non-intermediary assisted channel as hereinbefore defined, and

means for exercising the option right by confirming details for use of that ticket through a second low or no cost, non-intermediary assisted channel as hereinbefore defined.

Preferably, the ticket is an airline ticket, and the exercisable option right in the airline ticket is purchased through a retail channel.

In an alternative embodiment, the exercisable option right in the airline ticket is purchased directly through an airline ticketing system or through an electronic communication channel.

It is preferred that the retail channel is a supermarket, department store, or convenience store, where the purchasing of the option right is done wholly at a point of sale for the supermarket or store, or is done in two steps, the first step using a ticket dispensing terminal therewithin (such as a touch screen) to enable a consumer to select one or more tickets in accordance with desired details for use (such as origin and destination locations, number of tickets, level of fare) and then to dispense one or more dockets having a level code, barcode, or some other code, the second step requiring the consumer to present the one or more dockets to the point of sale for scanning and payment.

Preferably, for the exercising of the option right, the details for use of the ticket are confirmed either through a retail channel, a call centre, the internet, directly through an airline ticketing system, or through an electronic communication channel.

It is preferred that the electronic communication channel is an automated teller machine.

In an alternative embodiment, the electronic communication channel is an electronic funds transfer system at a point of sale, a personal digital assistant device, a personal computer with internet access, a suitably enabled mobile telephone, or a stand-alone internet kiosk.

The purchase of the exercisable option right in the airline ticket is preferably according to air travel segments, to which are assigned different ticket classification levels representing corresponding confirmable flight details for use of the airline ticket.

Preferably, the confirmable flight details for use of the airline ticket comprise one or more of departure time, flight route, and seat number.

In a preferred form, the system includes means for cancelling the exercisable option right in the ticket if the option right is not exercised by an expiry date.

The purchase of the exercisable option right in the ticket is preferably conducted by electronic funds transfer.

### BRIEF DESCRIPTION OF THE DRAWINGS

In order that the invention may be readily understood and put into practical effect, reference will now be made to the accompanying diagrams, in which: —

FIG. 1 is a schematic overview diagram of the electronically facilitated, two phase, transaction system according to a preferred embodiment of the present invention,

FIG. 2 is a flow chart describing the steps of an example of the first phase of the system of FIG. 1 in use,

FIG. 3 is a flow chart describing the steps of the second phase of the system of FIG. 1 in use,

FIG. 4 is a flow chart diagram illustrating the hardware components for carrying out the steps of the first and second phases of the system of FIG. 1, and

FIG. 5 is a flow chart describing the steps of another example of the first phase of the system of FIG. 1 in use.

### DETAILED DESCRIPTION OF THE INVENTION

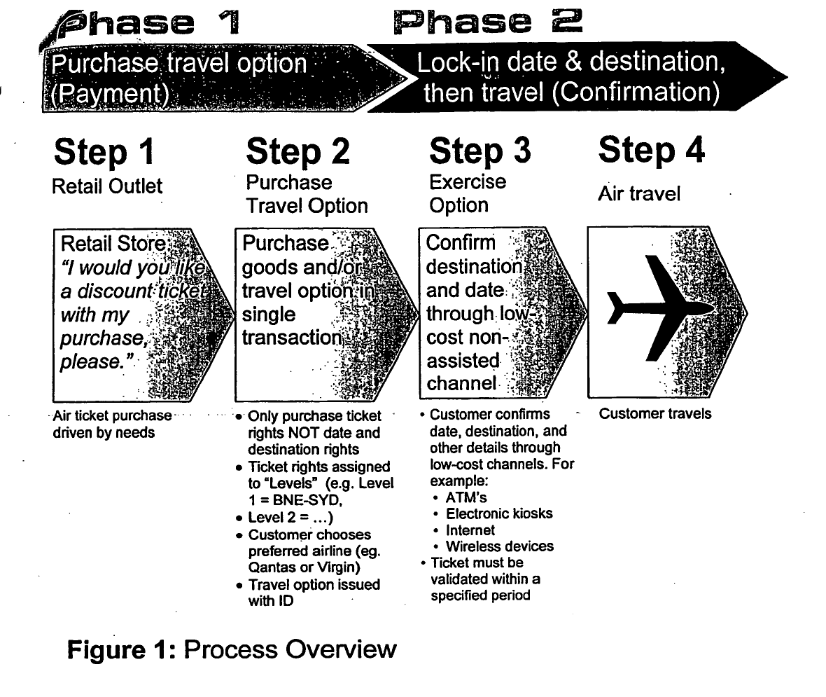

An overview of one preferred system of the present invention is illustrated in FIG. 1. The diagram illustrates two distinct phases: purchase and confirmation. Phase 1 delivers to the user or consumer a right to exercise an option (“travel option”) to travel at some time in the future in exchange for a predetermined ticket price. Phase 2 represents the exercising of the option that comprises confirming the flight details, such as date and time of travel, and departure/arrival locations.

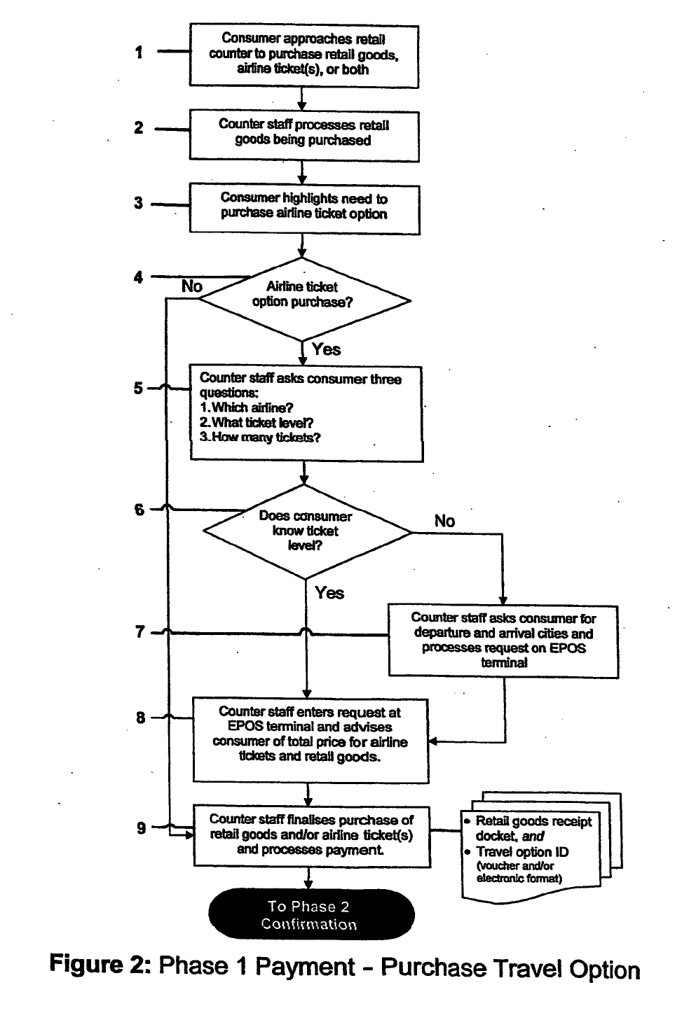

Referring now in more detail to the purchase phase, FIG. 2 is a flow chart in accordance with an embodiment of this invention illustrating the non-intermediary assisted process which a consumer would follow to purchase a travel option through a retail channel.

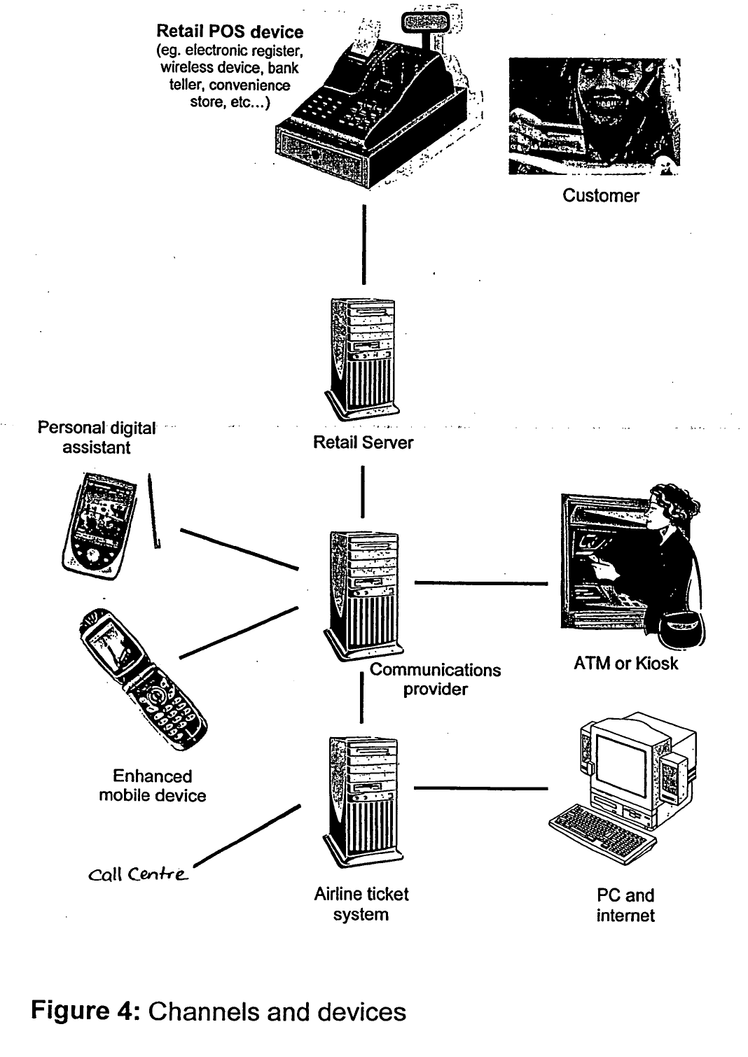

In addition, travel options may be purchased via any electronic communication channel or device as illustrated in FIG. 4. Retail channels and electronic communication channels or devices can include, but are not limited to, physical retail outlets, on-line retail outlets, stand alone internet kiosks, personal digital assistants (PDA's), personal computers with internet access, suitably enabled mobile phones (such as WAP phones and 3-G phones), or any other device that is operable to connect, either wirelessly or through wired connections, to an airline ticketing system.

Steps 1 to 3 in FIG. 2 represent anticipated buyer actions at the end of a retail shopping experience. At step 4, the buyer has decided if he/she wishes to purchase a travel option. In the case of a self-service purchase through other non-intermediary assisted channels, the consumer would adopt the dual role of counter staff and consumer.

Steps 5 to 8 in FIG. 2 embody the payment process for the travel option. In a physical retail outlet, this process would be made as efficient as possible by the use of ticket classification levels or codes that represent air travel between predetermined locations in ascending value order. For example, a “Level 1” ticket classification may represent the cheapest travel option for travel between the short distance, high traffic, air segment of Sydney-Melbourne, Australia. Conversely, a “Level 6” ticket classification may represent a moderately expensive discount travel option between Sydney and Townsville, Australia.

Step 9 in FIG. 2 represents the final step of Phase 1 whereby the consumer is issued with a travel option identification number (ID). When purchasing through a physical retail outlet, it is envisaged the ID would be printed on a separate airline travel option voucher and provided to the consumer. When purchasing a travel option via non-intermediary assisted channels represented by, but not limited to, the devices displayed in FIG. 4, the ID would be communicated electronically to the device for storage and subsequent use during Phase 2.

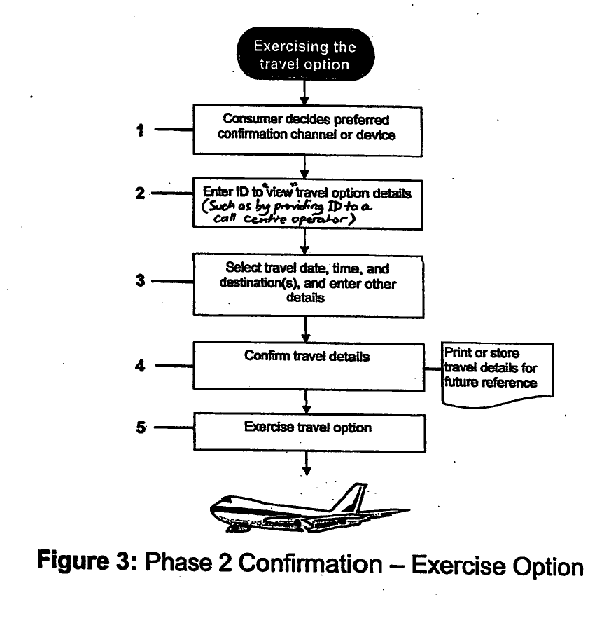

FIG. 3 represents the confirmation phase (Phase 2) by which the consumer exercises the option to travel. The confirmation phase can occur without being limited to any channel or device illustrated in FIG. 4.

Confirmation would preferably occur through a self-service, low-cost, non-intermediary assisted channel or device that communicates directly with the airline ticketing system. Once confirmation is finalised, the consumer has exercised his/her option to travel.

Phase 2 can only occur once the consumer has been issued with a travel option ID. In step 2, FIG. 3, the ID is provided or confirmed via the preferred channel or device to retrieve the travel option details. The consumer is then prompted to select travel date, time and destination(s) in step 3. Destination restrictions will apply based upon the level of ticket purchased. At this stage, the consumer would also be prompted to enter personal details, such as frequent flyer number, meal preferences, and the like.

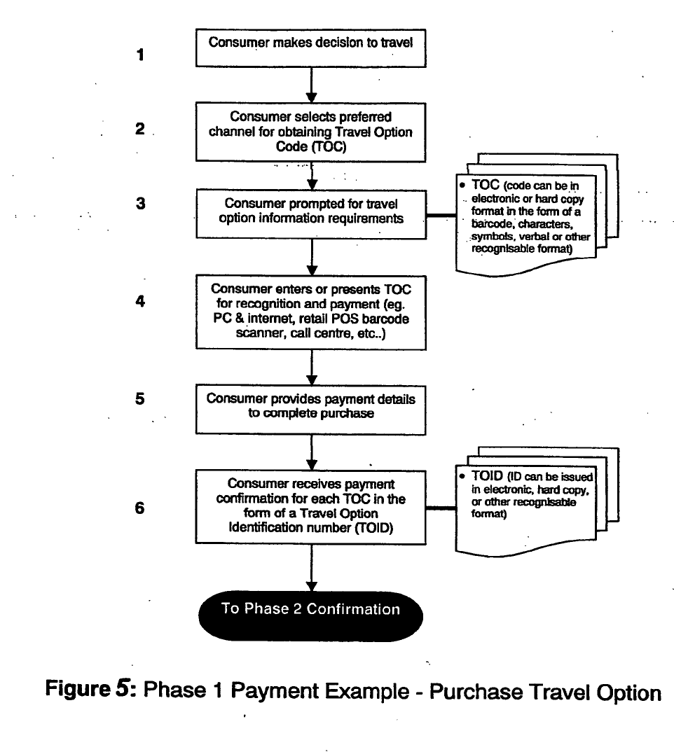

FIG. 5 is a flow chart in accordance with another embodiment of this invention illustrating the non-intermediary assisted process which a consumer would follow to purchase a travel option through a non-intermediary assisted channel.

During this process a consumer may obtain a docket with a barcode (or some other form of code) that represents a travel option for travel between certain locations with corresponding fare conditions for presentation at a retail outlet for payment. Such a docket may be obtained through any of the following non-intermediary assisted channels:

In-store docket dispensing terminal

In-store information points (e.g. electronic (viz. flat panel TV's) or non-electronic advertising displays)—which may be interactive or non-interactive to the consumer,

Personal Computer & Internet

Electronic (Internet) Kiosk

Mobile telephone device

Call centre

Other device or combination of devices.

The barcode, level code, or other form of code (“Code”) can be presented for quick scanning and payment at the retailer's POS. The code can be communicated verbally or by characters or symbols.

In a first example of use in accordance with FIG. 2, the consumer decides to purchase a travel option through a supermarket at the same time as she purchases other goods therefrom, and advises the cashier at the point of sale of the desired ticket classification level. The cashier is not obligated to provide advice in return which may slow the cashier's queue. The supermarket may include in-store information points to assist travel option purchasers seeking advice. Payment is made by cash, debit card, or credit card in the normal manner, and the consumer is issued with a travel option identification number on her shopping docket or on a separate payment confirmation voucher representing a particular level of travel.

In a second example of use in accordance with FIG. 5, the supermarket includes ticket dispensing terminals (such as touch screens) among the goods for sale that enable consumers to select one or more tickets in accordance with desired details for use (such as origin and destination locations, number of tickets level of fare) and then to dispense one or more dockets having a level code, barcode, or some other code, the next step requiring the consumer to present the one or more dockets to the point of sale for scanning and payment. This example will help to avoid supermarket queues at the point of sale or register/checkout, which may arise in the above first example of use by consumers requesting assistance from the cashier or checkout staff in selecting the ticket classification level or other details for use.

All revenue from purchases of travel options is deposited into the supermarket's bank account and the payment is recorded as a liability or debt to the airline. The supermarket operator may invest the accumulated revenue as desired. The consumer, at a time of convenience, exercises the travel option by confirming travel details through the internet, where the consumer, using a suitable website, enters the travel option identification number and, by a series of prompts, enters preferred travel dates. The website then displays a list of available flights (with associated airline, travel route and departure/arrival times for each of the dates). The consumer then selects from the list of available flights and receives a booking reference. The travel option identification number is then automatically transmitted electronically to the supermarket server for processing. The supermarket operator reconciles the travel option identification number with the price of the ticket, and schedules an overnight electronic funds transfer of an amount corresponding to the price, less margins, from its account into the airline's bank account. A small margin is retained by the supermarket operator as its own distribution margin, and another small margin is set aside and scheduled for an overnight electronic funds transfer into the web site's bank account. Other margins may be disbursed as negotiated with the system provider.

In the course of the consumer deciding to purchase a travel option, the consumer selects an air travel segment, to which is assigned a specific ticket classification level representing one of a variety of confirmable flight details for use of the airline ticket. A mid-category discount airfare for the Sydney-Brisbane travel segment is selected which is assigned a ticket classification level 1C. Selectable travel segments may be based on criteria other than specific departure/arrival locations, such as on the criteria of a common fare, distance or zones, or route demand. The ticket classification level 1C represents a particular fare category, which may be selected from the group ranging from a fully flexible fare category where the consumer can fly on any flight at any time, to a non-flexible fare category where the consumer can fly only on, say, Wednesday flights.

Numerous advantages of the invention may be identified or achieved from the foregoing description. These advantages include a significant reduction in the overall cost of the ticket to consumers, an expansion in the market availability of tickets by making tickets more accessible and more convenient to purchase and confirm, an increase in the ticket revenue margin for the vendor (such as an airline), adoption of existing infrastructure for carrying out much of the system whereby strategic commercial partnerships may be established between vendor on the one hand, and the retail channel (such as a supermarket chain) and/or provider of the electronic communication channel (such as a bank) on the other hand.

Various modifications may be made in details of system design and execution without departing from the scope and ambit of the invention.

1-13. (Canceled)

14. An electronically facilitated, two phase, transaction system for the purchase and confirmation of a ticket in an event having a timetable of event times, the system comprising:
means for purchasing an exercisable option right in the ticket through a first low or no cost, non-intermediary assisted channel; and
means for exercising the option right by confirming details for use of that ticket through a second low or no cost, non-intermediary assisted channel.

15. The system of claim 14, wherein the ticket is an airline ticket and the event is an airline flight.

16. The system of claim 15, wherein the exercisable option right in the airline ticket is purchased through a retail channel.

17. The system of claim 15, wherein the exercisable option right in the airline ticket is purchased directly through an airline ticketing system or through an electronic communication channel.

18. The system of claim 16, wherein the retail channel is a supermarket, department store, or convenience store, and wherein the purchasing of the option right is done at a point of sale for the retail channel.

19. The system of claim 16, wherein the retail channel is a supermarket, department store, or convenience store, and wherein the purchasing of the option right includes:
using a ticket dispensing terminal therewithin to
enable a consumer to select one or more details in accordance with desired details for use, and
dispense one or more dockets having a level code, barcode, or some other code; and
requiring the consumer to present the one or more docket to the point of sale for scanning and payment.

20. The system of claim 15, wherein exercising of the option right includes confirming the details for use of the ticket.

21. The system of claim 20, wherein the confirmation is performed by a retail channel, a call center, the internet, directly through an airline ticketing system, or through an electronic communication channel.

22. The system of claim 17, wherein the electronic communication channel is an automated teller machine.

23. The system of claim 21, wherein the electronic communication channel is an automated teller machine.

24. The system of claim 17, wherein the electronic communication channel is an electronic funds transfer system at a point of sale, a personal digital assistant device, a personal computer with internet access, a suitably enabled mobile telephone, or a stand-alone internet kiosk.

25. The system of claim 21, wherein the electronic communication channel is an electronic funds transfer system at a point of sale, a personal digital assistant device, a personal computer with internet access, a suitably enabled mobile telephone, or a stand-alone internet kiosk.

26. The system of claim 15, wherein the purchase of the exercisable option right in the airline ticket is according to air travel segments, to which are assigned different ticket classification levels representing corresponding confirmable flight details for use of the airline ticket.

27. The system of claim 26, wherein the confirmable flight details for use of the airline ticket include one or more of departure time, flight route, and seat number.

28. The system of claim 14, wherein the system includes means for cancelling the exercisable option right in the ticket if the option right is not exercised by an expiry date.

29. The system of claim 14, wherein the purchase of the exercisable option right in the ticket is conducted by electronic funds transfer.
